(19) United States
(12) Patent Application Publication
(10) Pub. No.: US 2016/0047351 A1
(43) Pub. Date: Feb. 18, 2016

(54) CONTROL APPARATUS FOR INTERNAL COMBUSTION ENGINE

(71) Applicants: Susumu HASHIMOTO, Susono-shi, Shizuoka-ken (JP); Shinichi MITANI, Susono-shi, Shizuoka-ken (JP)

(72) Inventors: Susumu HASHIMOTO, Susono-shi, Shizuoka-ken (JP); Shinichi MITANI, Susono-shi, Shizuoka-ken (JP)

(73) Assignee: TOYOTA JIDOSHA KABUSHIKI KAISHA, Toyota-shi, Aichi-ken (JP)

(21) Appl. No.: 14/780,266

(22) PCT Filed: Mar. 20, 2014
(86) PCT No.: PCT/IB2014/000395

§ 371 Date: Sep. 25, 2015

(30) Foreign Application Priority Data
Mar. 27, 2013 (JP) 2013-066801

(51) Int. Cl. F02P 5/145

(52) U.S. Cl. CPC F02P 5/145

(57) ABSTRACT

In a control apparatus for an internal combustion engine, which implements temperature increasing processing in which an ignition timing is retarded to a predetermined target ignition timing in order to increase an exhaust gas temperature, a period required for an actual ignition timing to become equal to the target ignition timing following the start of retardation of the ignition timing during the temperature increasing processing is lengthened when a startup torque, which is a torque generated by the internal combustion engine during a startup process, is small.

### BACKGROUND OF THE INVENTION

1. Field of the Invention

The invention relates to a control apparatus for a spark ignition type internal combustion engine, and more particularly to a technique for increasing a temperature of a component disposed in an exhaust system of the internal combustion engine by retarding an ignition timing.

2. Description of Related Art

In a conventional technique employed in a spark ignition type internal combustion engine, an exhaust gas temperature is increased by retarding an ignition timing during a fast idle operation following completion of startup, with the result that a temperature of a component (an exhaust gas purification catalyst or the like, for example) disposed in an exhaust system is raised early. In another proposed technique (see Japanese Patent Application Publication No. 2009-121255 (JP 2009-121255 A), for example), when the ignition timing is retarded from a suitable ignition timing for starting the internal combustion engine to a suitable ignition timing for the fast idle operation, the ignition timing is retarded either in steps or continuously.

Incidentally, when the ignition timing is retarded while a fuel property is heavy or an internal temperature of a cylinder (an in-cylinder temperature) is extremely low, a combustion condition of an air-fuel mixture may become unstable. In this case, reductions may occur in an engine rotation speed and a torque generated by the internal combustion engine.

In the conventional techniques described above, an amount of air taken into the internal combustion engine during retardation of the ignition timing is taken into consideration, but the fuel property and the internal temperature of the cylinder are not taken into consideration, and therefore the combustion condition of the air-fuel mixture may become unstable when the ignition timing is retarded.

### SUMMARY OF THE INVENTION

An object of the invention is to provide a control apparatus for a spark ignition type internal combustion engine, which executes processing to increase an exhaust gas temperature by retarding an ignition timing such that the exhaust gas temperature is increased while suppressing instability in a combustion condition of an air-fuel mixture.

According to the invention, in a control apparatus for a spark ignition type internal combustion engine, which implements temperature increasing processing in which an ignition timing is retarded to a predetermined target ignition timing in order to increase an exhaust gas temperature, a period required for an actual ignition timing to become equal to the target ignition timing following the start of retardation of the ignition timing is lengthened when a startup torque, which is a torque generated by the internal combustion engine during a startup process, is small.

A control apparatus for an internal combustion engine according to an aspect of the invention includes: temperature increasing apparatus configured to execute exhaust gas temperature increasing processing, which is processing in which an ignition timing is retarded to a predetermined target ignition timing; obtaining unit configured to obtain a startup torque, which is a torque generated by the internal combustion engine during a startup process; and a controller configured to, during execution of the temperature increasing processing, make a period extending from a point, at which retardation of the ignition timing starts, to a point, at which an actual ignition timing becomes equal to the target ignition timing, longer when the startup torque obtained by the obtaining unit is small than when the startup torque is large.

When the ignition timing is retarded to the target ignition timing immediately while a fuel property is heavy or an in-cylinder temperature is low, a combustion condition of an air-fuel mixture may become unstable. A possible reason for this is that when the fuel property is heavy or the in-cylinder temperature is low, a vaporization delay, in which fuel is not vaporized immediately, is more likely to occur than when the fuel property is light or the in-cylinder temperature is high, and as a result, a lean deviation, in which an air-fuel ratio of the air-fuel mixture increases beyond a pre-envisaged air-fuel ratio, may occur.

If the ignition timing is retarded when the air-fuel ratio of the air-fuel mixture is lean due to a fuel vaporization delay, the combustion condition of the air-fuel mixture becomes unstable. When the combustion condition of the air-fuel mixture is unstable, an engine rotation speed and a torque generated by the internal combustion engine may decrease, leading to a reduction in the exhaust gas temperature. As a result, a drivability of the internal combustion engine may deteriorate, making it even more difficult to raise the exhaust gas temperature.

Here, the startup torque is smaller when the fuel property is heavy than when the fuel property is light. Further, the startup torque is smaller when an internal temperature of a cylinder of the internal combustion engine (the in-cylinder temperature) is low than when the in-cylinder temperature is high. Hence, the startup torque decreases as the fuel property becomes heavier and/or the in-cylinder temperature becomes lower.

The control apparatus for an internal combustion engine according to this aspect makes the period (to be referred to hereafter as a “delay period”) extending from the start of the temperature increasing processing (a start point of retardation of the ignition timing) to the point at which the ignition timing becomes equal to the target ignition timing longer when the startup torque is small than when the startup torque is large. According to this configuration, a timing at which the ignition timing is retarded to the target ignition timing is delayed when the fuel property is heavy or the in-cylinder temperature is low.

When the timing at which the ignition timing is retarded to the target ignition timing is delayed, the in-cylinder temperature is increased by combustion of the air-fuel mixture during the delay period. The in-cylinder temperature is therefore higher at the point where the ignition timing becomes equal to the target ignition timing. Hence, when the ignition timing is retarded to the target ignition timing, the fuel vaporization delay and the lean deviation of the air-fuel mixture are reduced. As a result, the combustion condition of the air-fuel mixture is unlikely to deteriorate even when the ignition timing is retarded to the target ignition timing.

When the fuel property is light or the in-cylinder temperature is high, on the other hand, the ignition timing is retarded to the target ignition timing immediately. When the fuel property is light or the in-cylinder temperature is high, the fuel is vaporized easily, and therefore the combustion condition of the air-fuel mixture is unlikely to deteriorate even if the ignition timing is retarded to the target ignition timing immediately.

Hence, when the ignition timing is retarded with the aim of increasing the exhaust gas temperature by the control apparatus for an internal combustion engine according to the invention, the exhaust gas temperature can be increased while suppressing instability in the combustion condition of the air-fuel mixture. In particular, when the fuel property is heavy or the in-cylinder temperature is low, the exhaust gas temperature can be increased as quickly as possible.

In the control apparatus for an internal combustion engine according to this aspect, the controller may increase a retardation amount of the ignition timing either continuously or in steps when lengthening the delay period. When the retardation amount of the ignition timing is increased continuously, the controller may reduce an ignition timing retardation amount (a retardation amount increase speed) per unit time as the startup torque decreases. Further, when the retardation amount of the ignition timing is increased in steps, the controller may reduce an ignition timing retardation amount per step or lengthen a period in which the retardation amount of each step is maintained as the startup torque decreases.

When the ignition timing is increased continuously or in steps in accordance with the method described above, the delay period lengthens as the startup torque decreases. Further, when the ignition timing retardation amount is increased continuously or in steps, the ignition timing retardation amount increases as the in-cylinder temperature rises, and therefore the ignition timing retardation amount can be increased without destabilizing the combustion condition of the air-fuel mixture. Furthermore, by modifying the ignition timing continuously or in steps, rapid variation in the engine rotation speed and the torque can be avoided.

Note that the controller may increase the retardation amount of the ignition timing logarithmically over time when increasing the retardation amount of the ignition timing continuously. Further, the controller may reduce an increase amount per step over time when increasing the retardation amount of the ignition timing in steps. By increasing the ignition timing retardation amount using these methods, the ignition timing can be retarded while suppressing variation in the engine rotation speed and the torque.

In the control apparatus for an internal combustion engine according to this aspect, the controller may retard the ignition timing to the target ignition timing immediately when the startup torque equals or exceeds a threshold, and when the startup torque is smaller than the threshold, the controller may make the delay period steadily longer as the startup torque decreases.

Here, the “threshold” is a minimum startup torque at which the combustion condition of the air-fuel mixture is not expected to become unstable even when the ignition timing is retarded to the target ignition timing immediately, or a value obtained by adding a margin to the minimum startup torque. The threshold may be determined in advance by conformance processing using experiments and the like.

According to the configuration described above, a situation in which the delay period is lengthened unnecessarily (a situation in which the timing at which the actual ignition timing becomes equal to the target ignition timing is delayed unnecessarily) can be avoided. In other words, a situation in which the delay period is lengthened unnecessarily when the combustion condition of the air-fuel mixture would not become unstable even if the ignition timing were retarded to the target ignition timing immediately can be avoided. As a result, the exhaust gas temperature can be raised at the earliest timing.

According to this aspect of the invention, in a control apparatus for an internal combustion engine, which executes processing for increasing an exhaust gas temperature by retarding an ignition timing, the exhaust gas temperature can be increased while suppressing instability in a combustion condition of an air-fuel mixture.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic view showing a configuration of an internal combustion engine to which the invention is applied;

FIG. 2 is a view showing a correlation between a fuel property, an in-cylinder temperature, and a startup torque;

FIG. 3 is a view showing a relationship between the startup torque of the internal combustion engine and a delay period;

FIG. 4 is a timing chart showing a method of retarding an ignition timing continuously during temperature increasing processing;

FIG. 5 is a view showing a relationship between the startup torque of the internal combustion engine and an initial retardation amount;

FIG. 6 is a timing chart showing another method of retarding the ignition timing continuously during the temperature increasing processing;

FIG. 7 is a view showing temporal variation in an air-fuel ratio of an air-fuel mixture, the ignition timing, a torque of the internal combustion engine, an engine rotation speed, and an exhaust gas temperature during execution of the temperature increasing processing;

FIG. 8 is a flowchart showing a processing routine executed by an electronic control unit (ECU) when the temperature increasing processing is implemented according to a first embodiment;

FIG. 9 is a timing chart showing a method of retarding the ignition timing in steps during the temperature increasing processing;

FIG. 10 is a view showing temporal variation in the engine rotation speed, the ignition timing, an injection proportion, and an injection timing during execution of the temperature increasing processing; and

FIG. 11 is a flowchart showing a processing routine executed by the ECU when the temperature increasing processing is implemented according to a second embodiment.

### DETAILED DESCRIPTION OF EMBODIMENTS

Specific embodiments of the invention will be described below on the basis of the drawings. Unless specific description is provided to the contrary, the technical scope of the invention is not limited to dimensions, materials, shapes, relative arrangements, and so on of constituent components described in the embodiments.

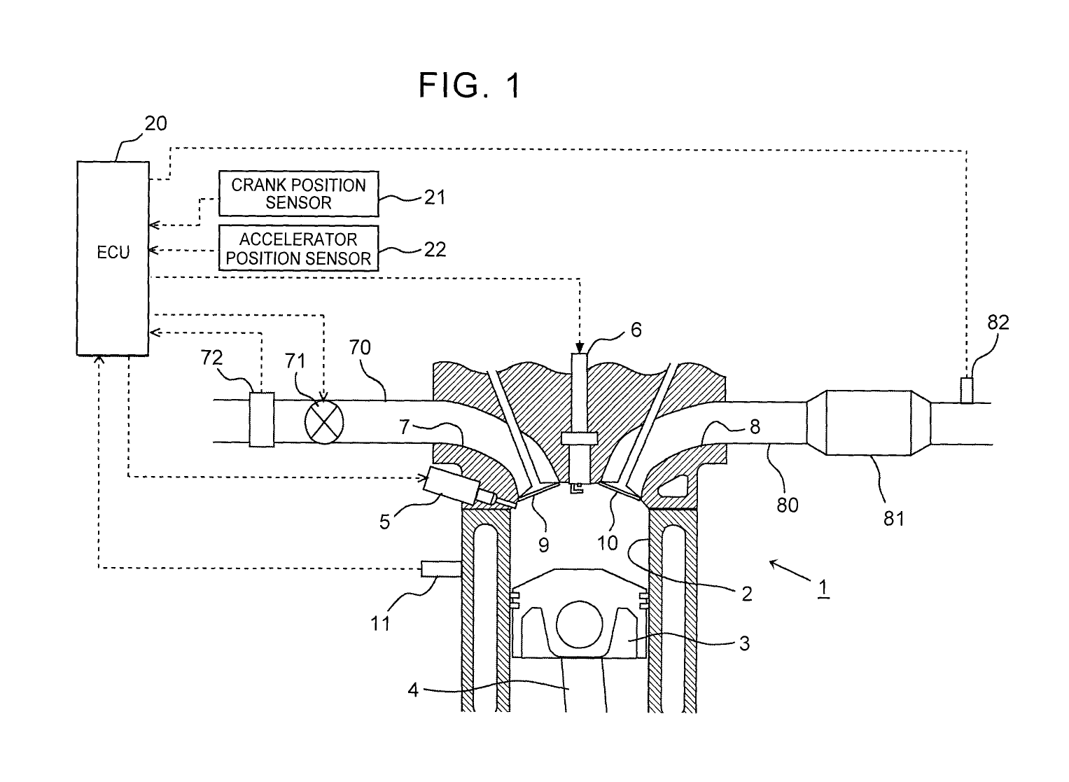

A first embodiment of the invention will now be described on the basis of FIGS. 1 to 9. FIG. 1 is a schematic view showing a configuration of an internal combustion engine to which the invention is applied. An internal combustion engine 1 shown in FIG. 1 is a spark ignition type internal combustion engine (a gasoline engine) having a plurality of cylinders. Note that FIG. 1 shows only one of the plurality of cylinders.

A piston 3 is housed in each cylinder 2 of the internal combustion engine 1 to be free to slide. The piston 3 is coupled to an output shaft (a crankshaft), not shown in the drawing, via a connecting rod 4. A fuel injection valve 5 through which fuel is injected into the cylinder 2 and a spark plug 6 that generates a spark in the cylinder 2 are attached to each cylinder 2.

An interior of the cylinder 2 communicates with an intake port 7 and an exhaust port 8. An open end of the intake port 7 in the cylinder 2 is opened and closed by an intake valve 9. An open end of the exhaust port 8 in the cylinder 2 is opened and closed by an exhaust valve 10. The intake valve 9 and the exhaust valve 10 are driven to open and close respectively by an intake cam and an exhaust cam, not shown in the drawing.

The intake port 7 communicates with an intake passage 70. A throttle valve 71 is disposed in the intake passage 70. An air flow meter 72 is disposed in the intake passage 70 upstream of the throttle valve 71.

The exhaust port 8 communicates with an exhaust passage 80. An exhaust gas purification apparatus 81 is disposed in the exhaust passage 80. At least one of a three-way catalyst, a NO_{X} occlusion reduction catalyst, a selective reduction NO_{X} catalyst, and an oxidation catalyst is housed in a tubular casing of the exhaust gas purification apparatus 81.

An ECU 20 is annexed to the internal combustion engine 1 thus configured. The ECU 20 is an electronic control unit constituted by a central processing unit (CPU), a read only memory (ROM), a random access memory (RAM), a backup RAM, and so on. Detection signals from various sensors such as the aforesaid air flow meter 72, a water temperature sensor 11, a crank position sensor 21, an accelerator position sensor 22, and an exhaust gas temperature sensor 82 are input into the ECU 20.

The air flow meter 72 outputs an electric signal correlating with an amount (a mass) of intake air flowing through the intake passage 70. The water temperature sensor 11 outputs an electric signal correlating with a temperature of cooling water circulating through the internal combustion engine 1. The crank position sensor 21 outputs a signal correlating with a rotation position of the crankshaft. The accelerator position sensor 22 outputs an electric signal correlating with an operation amount (an accelerator depression amount) of an accelerator pedal, not shown in the drawing. The exhaust gas temperature sensor 82 is disposed in the exhaust passage 80 downstream of the exhaust gas purification apparatus 81, and outputs an electric signal correlating with a temperature of exhaust gas flowing out of the exhaust gas purification apparatus 81.

The ECU 20 is electrically connected to various devices such as the fuel injection valve 5, the spark plug 6, and the throttle valve 71, and controls the various devices on the basis of the output signals from the various sensors described above. For example, the ECU 20 executes conventional control, such as fuel injection control, and temperature increasing processing for increasing the exhaust gas temperature upon completion of startup in the internal combustion engine 1 in accordance with an operating condition of the internal combustion engine 1, which is determined from the output signals of the crank position sensor 21, the accelerator position sensor 22, the air flow meter 72, and so on. A method of executing the temperature increasing processing according to this embodiment will be described below.

When a cold start is performed on the internal combustion engine 1, a temperature of the exhaust gas purification apparatus 81 is below an activation temperature region of the exhaust gas purification apparatus 81. In this case, the temperature of the exhaust gas purification apparatus 81 must be raised rapidly in order to activate a purification capability of the exhaust gas purification apparatus 81. Meanwhile, in a conventional method, the exhaust gas temperature is increased by retarding an ignition timing to a predetermined target ignition timing upon the completion of startup in the internal combustion engine 1. Note that here, the “completion of startup in the internal combustion engine 1” is determined to have been reached when, following the start of cranking, an engine rotation speed of the internal combustion engine 1 reaches or exceeds a fixed rotation speed. The fixed rotation speed will be referred to hereafter as a startup determination rotation speed.

Incidentally, when the fuel used in the internal combustion engine 1 has a heavy property or an internal temperature of the cylinder 2 (an in-cylinder temperature) is extremely low, the fuel injected from the fuel injection valve 5 may not be vaporized immediately, and as a result, an air-fuel ratio of an air-fuel mixture may become lean. This phenomenon occurs particularly strikingly when fuel is injected from the fuel injection valve 5 during a compression stroke (i.e. when a compression stroke injection is performed) in the internal combustion engine 1 including the in-cylinder injection type fuel injection valve 5. A situation in which the fuel injected from the fuel injection valve 5 is not vaporized immediately is referred to as a vaporization delay. Further, a situation in which the air-fuel ratio of the air-fuel mixture becomes lean is referred to as a lean deviation.

Hence, when the ignition timing is immediately retarded to the target ignition timing or a compression stroke injection is performed using the completion of startup in the internal combustion engine 1 as a trigger in a case where the fuel used in the internal combustion engine 1 has a heavy property or the in-cylinder temperature is extremely low, a combustion condition of the air-fuel mixture may become unstable. When the combustion condition of the air-fuel mixture becomes unstable, reductions may occur in the engine rotation speed and the torque, leading to a reduction in the exhaust gas temperature.

In the temperature increasing processing according to this embodiment, on the other hand, a period (a delay period) required for an actual ignition timing to become equal to the target ignition timing following the start of retardation of the ignition timing is lengthened when the fuel property is heavy or the in-cylinder temperature is extremely low. More specifically, when the fuel property is heavy or the in-cylinder temperature is low, a timing at which the actual ignition timing becomes equal to the target ignition timing is delayed by gradually retarding the actual ignition timing from the target ignition timing upon the completion of startup to a target ignition timing suitable for the temperature increasing processing.

The heaviness of the fuel property and the in-cylinder temperature correlate with a startup torque of the internal combustion engine 1. Here, the “startup torque” is a torque generated by the internal combustion engine 1 during a startup process of the internal combustion engine 1, for example a startup period in which the engine rotation speed increases from a cranking rotation speed to the startup determination rotation speed.

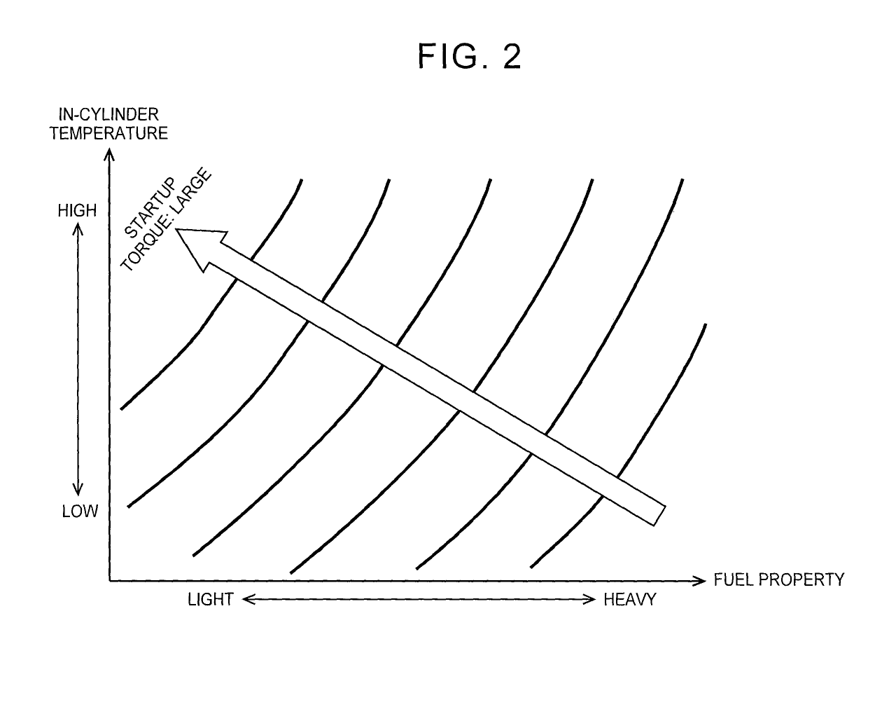

FIG. 2 is a view showing the correlation between the fuel property, the in-cylinder temperature, and the startup torque. In FIG. 2, the startup torque of the internal combustion engine 1 has a tendency to decrease as the heaviness of the fuel property increases. Further, the startup torque of the internal combustion engine 1 has a tendency to decrease as the in-cylinder temperature decreases. Hence, when the startup torque of the internal combustion engine 1 is small, the fuel property may be considered to be heavy and/or the in-cylinder temperature may be considered to be low.

Therefore, in the temperature increasing processing according to this embodiment, when the startup torque of the internal combustion engine 1 is smaller than a threshold, the ignition timing is retarded gradually, and when the startup torque of the internal combustion engine 1 equals or exceeds the threshold, the ignition timing is retarded to the target ignition timing immediately. Here, the “threshold” is a minimum startup torque at which it can be determined that the combustion condition of the air-fuel mixture will not become unstable even when the ignition timing is retarded to the target ignition timing immediately, or a value obtained by adding a margin to the minimum startup torque. The threshold is determined in advance by conformance processing using experiments and the like.

Note that the startup torque of the internal combustion engine 1 correlates with an increase speed of the engine rotation speed in at least a part of a startup period. Therefore, by determining the correlation between the increase speed of the engine rotation speed and the startup torque in advance through experiment, the startup torque can be determined using the increase speed of the engine rotation speed as a parameter. The startup torque of the internal combustion engine 1 also correlates with an indicated torque upon the completion of startup. Therefore, by determining the correlation between the indicated torque upon the completion of startup and the startup torque in advance through experiment, the startup torque can be determined using the indicated torque upon the completion of startup as a parameter. Note that the indicated torque may be determined using a conventional method such as calculating the indicated torque from a measurement value of an in-cylinder pressure sensor.

By lengthening the delay period when the startup torque of the internal combustion engine 1 is smaller than the threshold, the in-cylinder temperature increases during the delay period. In other words, the in-cylinder temperature is raised gradually by combustion heat generated from the air-fuel mixture during the delay period. When the ignition timing becomes equal to the target ignition timing, the in-cylinder temperature is high enough to eliminate the fuel vaporization delay. Hence, when the ignition timing becomes equal to the target ignition timing, the combustion condition of the air-fuel mixture is unlikely to deteriorate. As a result, reductions in the engine rotation speed and the torque can be avoided, and therefore the exhaust gas temperature can be increased while suppressing a reduction in a drivability of the internal combustion engine 1.

Further, since the in-cylinder temperature increases gradually during the delay period, the combustion condition of the air-fuel mixture is unlikely to deteriorate even when an ignition timing retardation amount is increased gradually. As a result, the exhaust gas temperature can be increased gradually while avoiding reductions in the engine rotation speed and the torque.

Hence, by executing the temperature increasing processing using the method described above, the exhaust gas temperature can be increased as quickly as possible while suppressing a reduction in the drivability of the internal combustion engine 1 even when the fuel property is heavy or the in-cylinder temperature is extremely low.

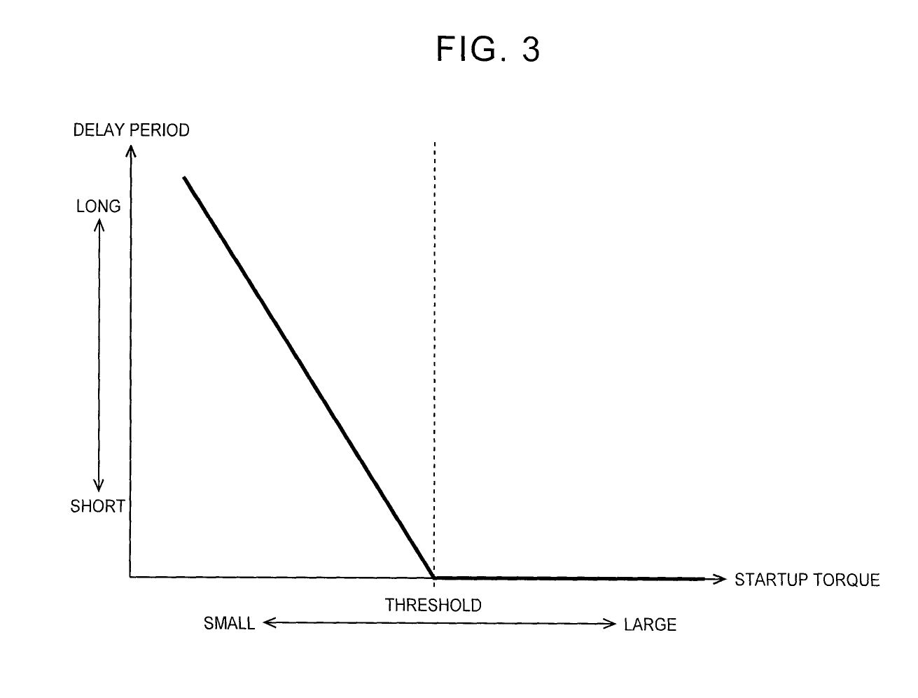

Incidentally, when the startup torque of the internal combustion engine 1 is smaller than the threshold, the fuel vaporization delay may increase steadily as the startup torque decreases. To solve this problem, in the temperature increasing processing according to this embodiment, as shown in FIG. 3, when the startup torque of the internal combustion engine 1 is smaller than the threshold, the delay period is lengthened steadily as the startup torque decreases. By modifying the length of the delay period in this manner, the exhaust gas temperature can be increased while suppressing deterioration of the combustion condition of the air-fuel mixture more reliably.

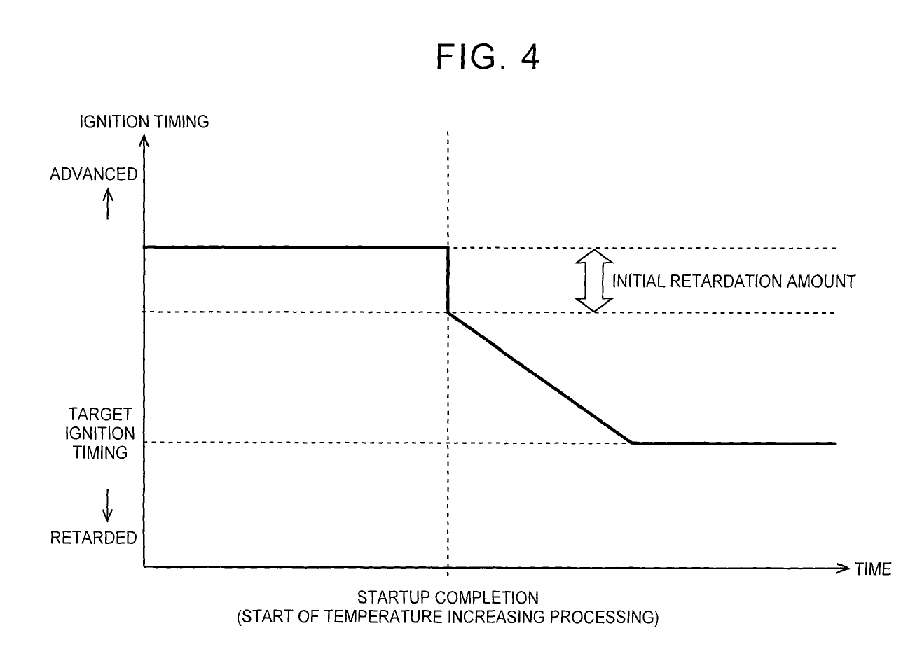

Note that from the viewpoint of activating the purification capability of the exhaust gas purification apparatus 81 early, the amount by which the ignition timing is retarded during the delay period is preferably maximized. Therefore, as shown in FIG. 4, the ignition timing may be retarded by a predetermined amount at a start point of the temperature increasing processing, and thereafter, the ignition timing retardation amount may be increased gradually. The predetermined amount used at this time is a maximum retardation amount at which deterioration of the combustion condition of the air-fuel mixture can be avoided (the predetermined amount will be referred to hereafter as an “initial retardation amount”).

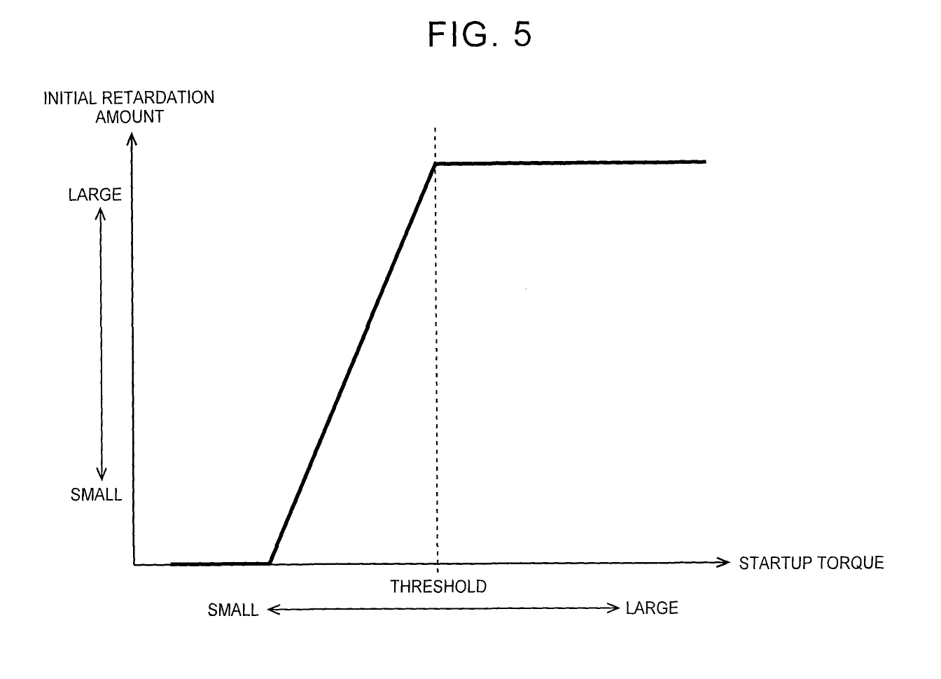

The initial retardation amount decreases as the heaviness of the fuel property increases and/or the in-cylinder temperature decreases. As shown in FIG. 5, therefore, when the startup torque is smaller than the threshold, the initial retardation amount is set at a steadily smaller value as the startup torque decreases. Note that when the startup torque of the internal combustion engine 1 is considerably smaller than the threshold, the combustion condition of the air-fuel mixture is more likely to become unstable, and therefore the initial retardation amount is set at zero. Further, when the startup torque of the internal combustion engine 1 equals or exceeds the threshold, the initial retardation amount is set to be equal to a difference between the ignition timing upon the completion of startup in the internal combustion engine 1 and the target ignition timing so that the ignition timing is retarded to the target ignition timing immediately.

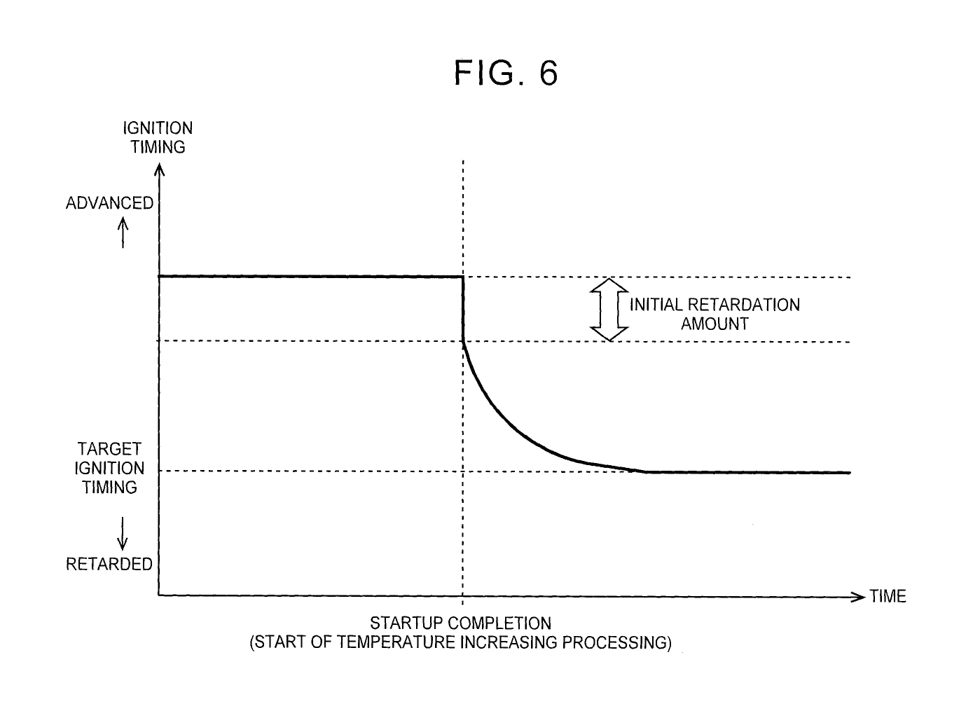

Incidentally, in the example shown in FIG. 4, the ignition timing retardation amount increases in proportion with the elapse of time, but the ignition timing retardation amount may be increased logarithmically relative to the elapse of time. In this case, as shown in FIG. 6, the ignition timing is delayed exponentially relative to the elapse of time. Here, the lean deviation of the air-fuel mixture during the delay period tends to decrease logarithmically (the air-fuel ratio of the air-fuel mixture tends to decrease logarithmically) relative to the elapse of time. Hence, by modifying the ignition timing retardation amount and the ignition timing in the manner described above, the ignition timing retardation amount can be maximized while avoiding reductions in the engine rotation speed and the torque.

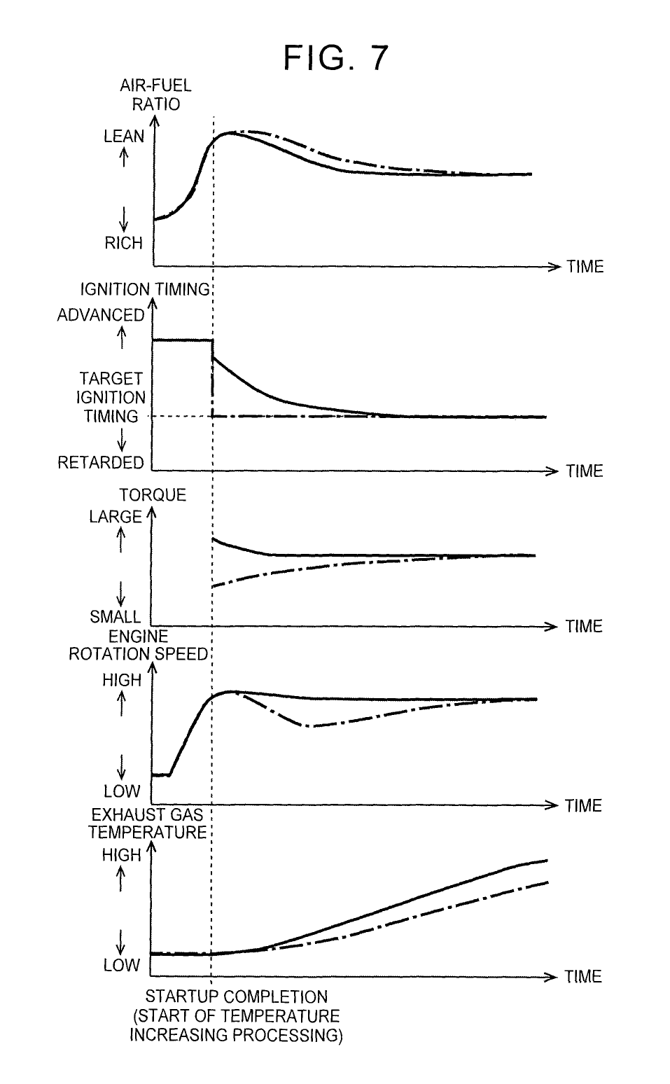

FIG. 7 shows temporal variation in the air-fuel ratio of the air-fuel mixture, the ignition timing, the torque of the internal combustion engine 1, the engine rotation speed, and the exhaust gas temperature during execution of the temperature increase processing. Solid lines in FIG. 7 show temporal variation in a case where the delay period is lengthened beyond zero when the startup torque is smaller than the threshold. Dot-dash lines in FIG. 7 show temporal variation in a case where the ignition timing is retarded to the target ignition timing immediately when the startup torque is smaller than the threshold.

When the ignition timing is retarded to the target ignition timing immediately using the completion of startup in the internal combustion engine 1 (the start of the temperature increasing processing) as a trigger in a case where the startup torque of the internal combustion engine 1 is smaller than the threshold, the combustion condition of the air-fuel mixture becomes unstable. When the combustion condition of the air-fuel mixture becomes unstable, the engine rotation speed and the torque of the internal combustion engine 1 decrease, and it becomes more difficult to raise the in-cylinder temperature and the exhaust gas temperature. Furthermore, when the in-cylinder temperature cannot be raised easily, it becomes more difficult to eliminate the lean deviation of the air-fuel ratio.

On the other hand, when the delay period is lengthened beyond zero and the ignition timing is varied gradually during the delay period in a case where the startup torque of the internal combustion engine 1 is smaller than the threshold, the combustion condition of the air-fuel mixture is more likely to be stable. When the combustion condition of the air-fuel mixture is stable, the engine rotation speed and the torque of the internal combustion engine 1 are less likely to decrease, and therefore the in-cylinder temperature and the exhaust gas temperature are more likely to increase. Furthermore, when the in-cylinder temperature increases, the lean deviation of the air-fuel ratio decreases.

Hence, when the temperature increasing processing is implemented using the method according to this embodiment, the exhaust gas temperature can be increased as quickly as possible while suppressing a reduction in the drivability of the internal combustion engine 1 even when the fuel property is heavy or the in-cylinder temperature is low. As a result, the purification capability of the exhaust gas purification apparatus 81 can be activated quickly.

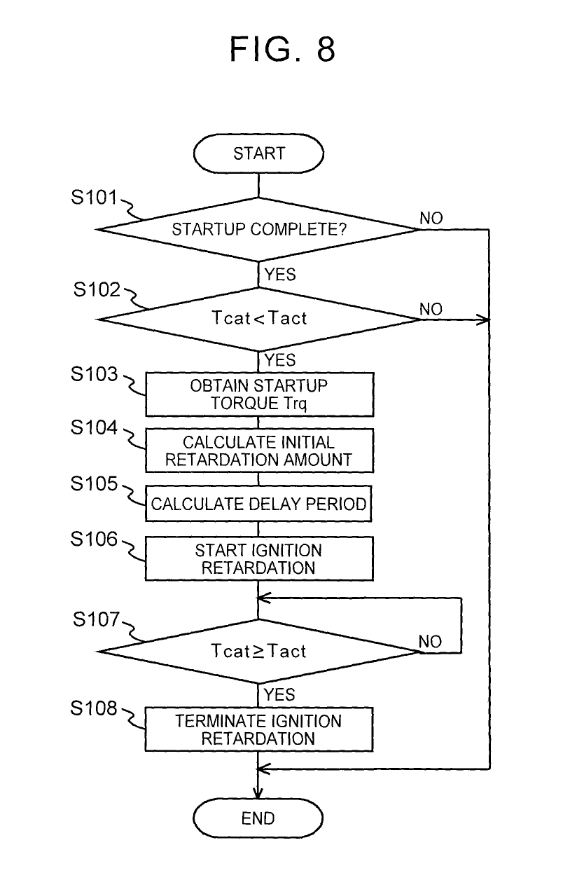

Procedures for executing the temperature increasing processing according to this embodiment will be described below with reference to FIG. 8. FIG. 8 shows a processing routine executed by the ECU 20 to implement the temperature increasing processing. This processing routine is stored in the ROM of the ECU 20 in advance, and executed using the completion of startup in the internal combustion engine 1 as a trigger.

In the processing routine of FIG. 8, first, the ECU 20 determines in processing of S101 whether or not startup of the internal combustion engine 1 is complete. More specifically, the ECU 20 determines that startup of the internal combustion engine 1 is complete when the engine rotation speed, which is calculated from a measurement value of the crank position sensor 21, has reached or exceeded a predetermined value.

When a negative determination is made in the processing of S101, the ECU 20 terminates execution of the current processing routine. When an affirmative determination is made in the processing of S101, on the other hand, the ECU 20 advances to processing of S102.

In the processing of S102, the ECU 20 first obtains a temperature Tcat of the exhaust gas purification apparatus 81. More specifically, the ECU 20 reads a measurement value of the exhaust gas temperature sensor 82 as a substitute value of the temperature of the exhaust gas purification apparatus 81. Note that when a temperature sensor is attached to the exhaust gas purification apparatus 81 in order to measure the temperature of the exhaust gas purification apparatus 81, the ECU 20 reads a measurement value of the temperature sensor as the temperature Teat of the exhaust gas purification apparatus 81. Next, the ECU 20 determines whether or not the temperature Tcat of the exhaust gas purification apparatus 81 is lower than a predetermined temperature Tact. The predetermined temperature Tact is a minimum temperature at which the purification capability of the exhaust gas purification apparatus 81 is activated, which is determined in advance through experiment.

When a negative determination is made in the processing of S102 (Tcat≧Tact), the ECU 20 terminates execution of the current routine. When an affirmative determination is made in the processing of S102 (Tcat<Tact), on the other hand, the ECU 20 advances to processing of S103.

In the processing of S103, the ECU 20 obtains a torque (a startup torque) Trq generated by the internal combustion engine 1 during the current startup process. It is assumed that the ECU 20 stores a history of the engine rotation speed during the startup period of the internal combustion engine 1 in the RAM or the like. The ECU 20 calculates an increase rate of the engine rotation speed from the history of the engine rotation speed, and calculates the startup torque Trq using the calculation result as a parameter. Note that when an in-cylinder pressure sensor is attached to the internal combustion engine 1, the ECU 20 may calculate the indicated torque from a measurement value of the in-cylinder pressure sensor upon the completion of startup in the internal combustion engine 1, and calculate the startup torque Trq using the calculation result as a parameter. By having the ECU 20 execute the processing of S103 in this manner, obtaining unit according to the invention is realized.

In processing of S104, the ECU 20 calculates the initial retardation amount on the basis of the startup torque Trq calculated in the processing of S103 and a correlation such as that illustrated in FIG. 5. When, at this time, the startup torque Trq equals or exceeds the threshold, the initial retardation amount is determined such that the ignition timing becomes equal to the target ignition timing. When the startup torque Trq is smaller than the threshold, on the other hand, the initial retardation amount is reduced steadily as the startup torque Trq decreases. Note that the correlation between the startup torque Trq and the initial retardation amount shown in FIG. 5 may be stored in the ROM of the ECU 20 in the form of a map or a relational expression. When the initial retardation amount is determined on the basis of a correlation such as that shown in FIG. 5 and the startup torque Trq equals or exceeds the threshold, the ignition timing is retarded to the target ignition timing immediately at the start point of the temperature increasing processing. When the startup torque Trq is smaller than the threshold, on the other hand, the initial retardation amount is reduced steadily as the startup torque Trq decreases, and therefore the ignition timing is not immediately retarded to the target ignition timing.

In processing of S105, the ECU 20 calculates the length of the delay period on the basis of the startup torque Trq calculated in the processing of S103 and a correlation such as that illustrated in FIG. 3. When, at this time, the startup torque Trq equals or exceeds the threshold, the delay period is set at zero. When the startup torque Trq is smaller than the threshold, on the other hand, the delay period is lengthened steadily as the startup torque Trq decreases. Note that the correlation between the startup torque Trq and the length of the delay period shown in FIG. 3 may be stored in the ROM of the ECU 20 in the form of a map or a relational expression.

In processing of S106, the ECU 20 starts to retard the ignition timing on the basis of the initial retardation amount and the length of the delay period determined in the processing of S104 and S105. When, at this time, the startup torque Trq equals or exceeds the threshold, the ignition timing is retarded to the target ignition timing immediately. When the startup torque Trq equals or exceeds the threshold, a fuel vaporization delay is unlikely to occur, and therefore the combustion condition of the air-fuel mixture is unlikely to become unstable even if the ignition timing is immediately retarded to the target ignition timing. As a result, the exhaust gas temperature can be increased without a reduction in the drivability of the internal combustion engine 1. When the startup torque Trq is smaller than the threshold, on the other hand, the ignition timing is retarded to the target ignition timing following the elapse of the delay period instead of being retarded to the target ignition timing immediately. During the delay period, the in-cylinder temperature increases gradually and the fuel vaporization delay gradually shortens. Therefore, by gradually retarding the ignition timing, the exhaust gas temperature can be increased without causing instability in the combustion condition of the air-fuel mixture. Note that when the ignition timing retardation amount is increased logarithmically relative to the elapse of time during the delay period, the retardation amount per unit time should be increased in an initial stage of the delay period and reduced in a final stage of the delay period.

By having the ECU 20 execute the processing of S104 to S106, temperature increasing apparatus and a controller according to the invention are realized. As a result, the temperature of the exhaust gas purification apparatus 81 can be increased as quickly as possible without a reduction in the drivability of the internal combustion engine 1 even when the fuel property is heavy or the in-cylinder temperature is extremely low.

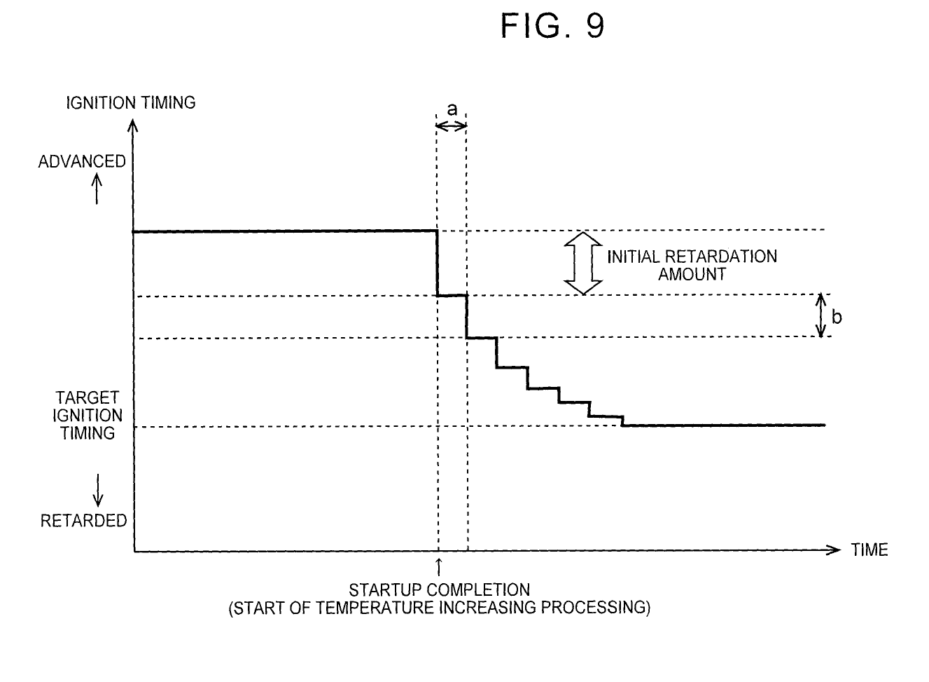

In the embodiment described above, an example in which the ignition timing retardation amount is increased continuously when gradually increasing the ignition timing retardation amount was described. As shown in FIG. 9, however, the ignition timing retardation amount may be increased in steps. At this time, the ignition timing retardation amount can be increased logarithmically relative to the elapse of time by increasing a period (a in FIG. 9) in which the retardation amount at each step is maintained as time elapses, or reducing an amount (b in FIG. 9) by which the retardation amount is increased per step as time elapses.

Further, in the embodiment described above, an example in which the invention is applied to an internal combustion engine having a fuel injection valve that injects fuel into a cylinder was described, but the invention may also be applied to an internal combustion engine having a fuel injection valve that injects fuel into the intake port.

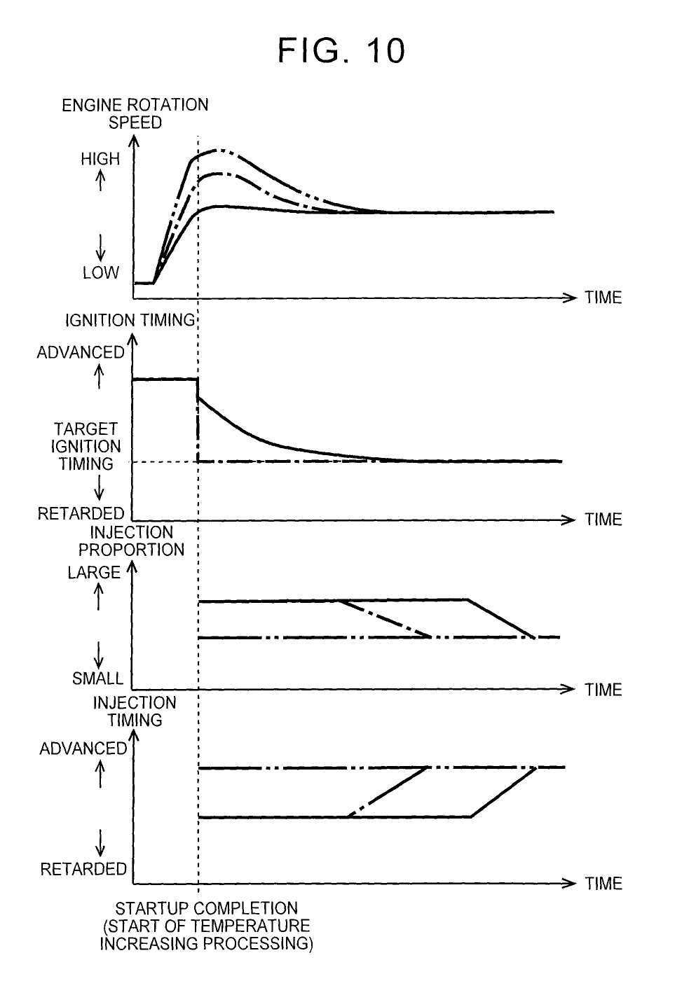

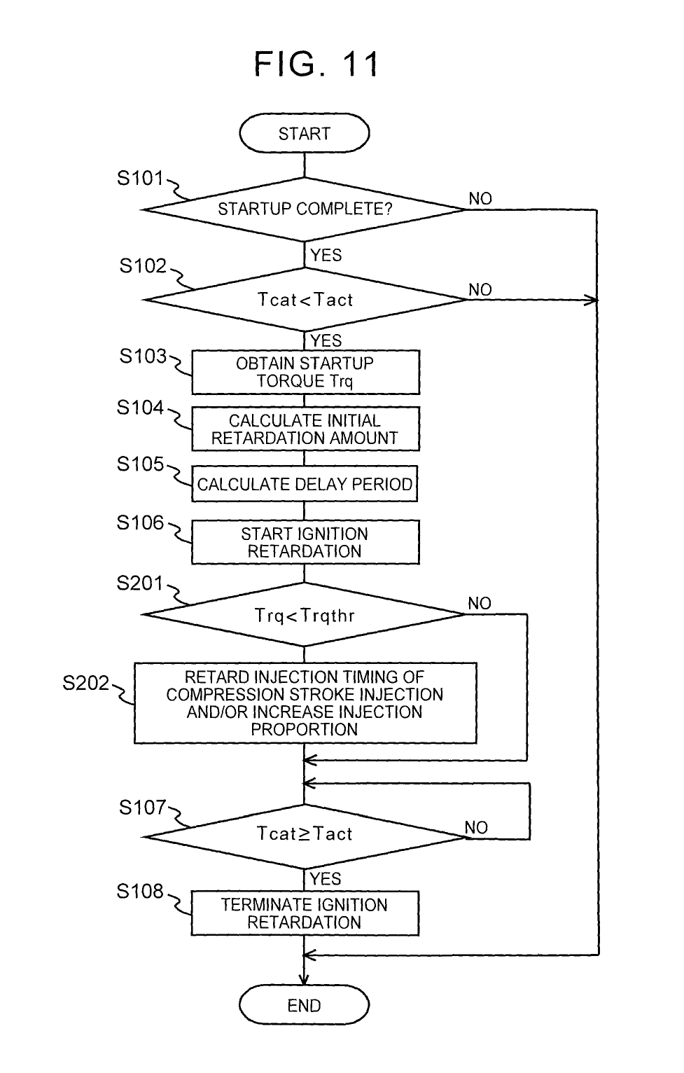

Next, a second embodiment of the invention will be described on the basis of FIGS. 10 and 11. Here, configurations that differ from the first embodiment will be described, but description of identical configurations will be omitted.

In the first embodiment described above, the length of the delay period and the initial retardation amount are modified in accordance with the magnitude of the startup torque of the internal combustion engine 1. In the second embodiment, on the other hand, a timing and a fuel injection amount of the compression stroke injection are modified in accordance with the magnitude of the startup torque of the internal combustion engine 1 in addition to the length of the delay period and the initial retardation amount.

When the fuel property is heavy or the in-cylinder temperature is low in a case where a compression stroke injection is performed or a compression stroke injection is performed together with fuel injection during an intake stroke (an intake stroke injection) following the completion of startup in the internal combustion engine 1, a vaporization delay occurs in the fuel injected in the compression stroke. As a result, a fuel concentration on a periphery of the spark plug 6 is likely to decrease. When the ignition timing is retarded under these conditions, the fuel concentration on the periphery of the spark plug 6 may decrease even further.

Hence, in the temperature increasing processing according to this embodiment, as shown by solid lines in FIG. 10, when the startup torque of the internal combustion engine 1 is smaller than the threshold, the injection timing of the compression stroke injection is also retarded, and/or a proportion of the fuel injected in the compression stroke injection relative to the intake stroke injection is increased. In other words, when the startup torque of the internal combustion engine 1 is smaller than the threshold, a delay period is provided between the point at which retardation of the ignition timing is started and the point at which the actual ignition timing becomes equal to the target ignition timing. When the startup torque of the internal combustion engine 1 is smaller than the threshold, the retardation amount and the injection proportion are preferably increased steadily as the startup torque of the internal combustion engine 1 decreases. By modifying the injection amount of the compression stroke injection and/or the injection proportion of the compression stroke injection relative to the intake stroke injection in this manner, a reduction in the fuel concentration on the periphery of the spark plug 6 can be suppressed. As a result, an ignitability of the fuel is increased, and the combustion condition of the air-fuel mixture is stabilized even further.

Incidentally, even when the startup torque of the internal combustion engine 1 equals or exceeds the threshold, if the ignition timing is retarded immediately to the target ignition timing in a case where the fuel possesses a certain degree of heaviness or the in-cylinder temperature is somewhat low, the fuel concentration on the periphery of the spark plug 6 may not be sufficiently high at the target ignition timing.

Hence, in the temperature increasing processing according to this embodiment, as shown by dot-dash lines in FIG. 10, when the startup torque of the internal combustion engine 1 equals or exceeds the threshold but is smaller than an appropriate value, the ignition timing is retarded to the target ignition timing immediately, and the injection timing of the compression stroke injection is retarded and/or the injection proportion of the compression stroke injection relative to the intake stroke injection is increased. Here, the “appropriate value” is a minimum startup torque at which the fuel concentration on the periphery of the spark plug 6 is expected to be sufficiently high when the ignition timing is retarded to the target ignition timing immediately, even if the ignition timing of the compression stroke injection is set at a preset injection timing and the injection proportion of the compression stroke injection relative to the intake stroke injection is set at a preset injection proportion, or a value obtained by adding a margin to this minimum startup torque. Note that the injection timing retardation amount and an amount by which the injection proportion is increased are preferably set to increase steadily as the startup torque of the internal combustion engine 1 decreases.

Further, when the startup torque of the internal combustion engine 1 equals or exceeds the appropriate value, as shown by the solid lines in FIG. 10, the ignition timing is retarded immediately to the target ignition timing, while the injection timing of the compression stroke injection and the injection proportion of the compression stroke injection relative to the intake stroke injection are set at the respective preset values.

By setting the injection timing of the compression stroke injection and the injection proportion of the compression stroke injection relative to the intake stroke injection using the method described above, the combustion condition of the air-fuel mixture can be stabilized more reliably when the ignition timing is retarded to the target ignition timing immediately.

Procedures for executing the temperature increasing processing according to this embodiment will be described below with reference to FIG. 11. FIG. 11 shows a processing routine executed by the ECU 20 to implement the temperature increasing processing. In the processing routine shown in FIG. 11, identical processes to the processing routine of the first embodiment (see FIG. 8) have been allocated identical reference symbols.

In the processing routine of FIG. 11, the ECU 20 executes processing of S201 and S202 after executing the processing of S106. In the processing of S201, the ECU 20 determines whether or not the startup torque Trq of the internal combustion engine 1 is smaller than an appropriate value Trqthr. When an affirmative determination is made in S201 (Trq<Trqthr), the ECU 20 advances to the processing of S202.

In the processing of S202, the ECU 20 retards the injection timing of the compression stroke injection and/or increases the injection proportion of the compression stroke injection relative to the intake stroke injection. At this time, the retardation amount and the injection proportion increase are set to increase as the startup torque Trq decreases. By modifying the injection timing of the compression stroke injection and/or the injection proportion of the compression stroke injection relative to the intake stroke injection in this manner, the ignitability of the air-fuel mixture can be increased when the ignition timing is retarded. As a result, a combustion stability of the air-fuel mixture can be improved even further.

Note that when a negative determination is made in the processing of S201 (Trq≧Trqthr), the ECU 20 skips the processing of S202 and advances to processing of S107. In this case, the injection timing of the compression stroke injection and/or the injection proportion of the compression stroke injection relative to the intake stroke injection are set at the respective preset values.

According to the second embodiment, the combustion condition of the air-fuel mixture can be stabilized even further when the ignition timing is retarded during the temperature increasing processing. As a result, the exhaust gas temperature can be increased even more reliably while even more reliably suppressing a reduction in the drivability of the internal combustion engine 1.

Note that in this embodiment, an example in which the temperature increasing processing is implemented in a spark ignition type internal combustion engine in which the fuel injection valve is disposed in the cylinder was described. However, in a case where the temperature increasing processing is implemented in an internal combustion engine having both a fuel injection value that injects fuel into the cylinder and a fuel injection valve that injects fuel into the intake port, a proportion of the amount of fuel injected in the compression stroke injection relative to an amount of fuel injected into the intake port may be modified instead of increasing the injection proportion of the compression stroke injection relative to the intake stroke injection.

1. A control apparatus for an internal combustion engine, comprising:
a temperature increasing apparatus configured to execute exhaust gas temperature increasing processing, which is processing in which an ignition timing is retarded to a predetermined target ignition timing;
an obtaining unit configured to obtain a startup torque, which is a torque generated by the internal combustion engine during a startup process; and
a controller configured to, during execution of the temperature increasing processing, make a period extending from a point, at which retardation of the ignition timing starts, to a point, at which an actual ignition timing becomes equal to the target ignition timing, longer when the startup torque obtained by the obtaining unit is small than when the startup torque is large.

2. The control apparatus for an internal combustion engine according to claim 1, wherein the controller is configured to increase a retardation amount of the ignition timing continuously when lengthening the period.

3. The control apparatus for an internal combustion engine according to claim 2, wherein the controller is configured to increase the retardation amount of the ignition timing logarithmically relative to the elapse of time when increasing the retardation amount of the ignition timing continuously.

4. The control apparatus for an internal combustion engine according to claim 1, wherein the obtaining unit is configured to calculate the startup torque on the basis of an increase rate of a rotation speed of the internal combustion engine.

5. The control apparatus for an internal combustion engine according to claim 1, wherein the controller is configured to retard the ignition timing to the target ignition timing immediately when the startup torque equals or exceeds a threshold, and when the startup torque is smaller than the threshold, is configured to make the period steadily longer as the startup torque decreases.
